(19) United States
(12) Patent Application Publication
(10) Pub. No.: US 2022/0065273 A1
(43) Pub. Date: Mar. 3, 2022

(54) METHOD FOR ESTABLISHING HYDRAULIC READINESS, AND HYDRAULIC SYSTEM

(71) Applicant: Schaeffler Technologies AG & Co. KG, Herzogenaurach (DE)

(72) Inventors: Marco Grethel, Bühlertal (DE); Dominik Götz, Bühl (DE); Daniel Müller, Oberkirch (DE); Johannes Oser, Achern (DE)

(21) Appl. No.: 17/298,936

(22) PCT Filed: Nov. 13, 2019
(86) PCT No.: PCT/DE2019/100972

§ 371 Date: Jun. 1, 2021

(30) Foreign Application Priority Data
Dec. 3, 2018 (DE) 10 2018 130 700.4

(51) Int. Cl. F15B 19/00; F15B 20/00; F15B 21/044; F16D 48/02; F16H 61/00

(52) U.S. Cl. CPC F15B 19/005; F15B 20/005; F15B 20/008; F15B 21/044; F16H 2061/0068; F16H 61/0025; F16D 2048/0257; F16H 2061/004; F16D 48/02

(57) ABSTRACT

A method is for testing a hydraulic system (1), having a pump (2) which, in a first direction of rotation (3), conveys fluid to a first consumer (4) for a volume flow function and, in a second direction of rotation (5), conveys fluid to at least one second consumer (6) for an actuation function. The method includes testing hydraulic readiness of the hydraulic system (1); drawing fluid into the hydraulic system (1); ventilating the hydraulic system (1). A hydraulic system (1) carries out such a method, having a pump (2) which can be driven in a first direction of rotation (3) for a volume flow function and can be driven in a second direction of rotation (5) for an actuation function.

### CROSS-REFERENCE TO RELATED APPLICATIONS

This application is the U.S. National Phase of PCT Appln. No. PCT/DE2019/100972 filed Nov. 13, 2019, which claims priority to DE 10 2018 130 700.4 filed Dec. 3, 2018, the entire disclosures of which are incorporated by reference herein.

The present disclosure relates to a method for testing a hydraulic system, in particular for testing and/or establishing hydraulic readiness of the hydraulic system, wherein the hydraulic system has a pump which, in a first direction of rotation/cooling oil direction, conveys fluid to a first consumer for a volume flow function and, in a second direction of rotation/actuation direction, conveys fluid to at least one second consumer for an actuation function. The present disclosure also relates to a hydraulic system for carrying out such a method, having a pump which can be driven in a first direction of rotation for a volume flow function and in a second direction of rotation for an actuation function.

### BACKGROUND

Hydraulic systems with so-called electrically driven reversing pumps are already known from the prior art. One direction of rotation of the reversing pump can be assigned a volume flow function, such as a cooling oil function, and an actuation function can be assigned to the other direction of rotation of the reversing pump. Such hydraulic systems are known, for example, from DE 10 2018 112 663 A1, DE 10 2018 112 665 A1, DE 10 2018 113 316 A1 or DE 10 2018 114 789 A1. Other hydraulic systems are known from DE 10 2016 213 318 A1 and from WO 2012/113368 A1, among others.

### SUMMARY

However, the prior art always has the disadvantage that in so-called open hydraulic circuits, a drawing-in path can run empty, which can delay the availability of the hydraulic functions until the pump draws in and the path is ventilated. In particular, such idling often occurs with large suction heights and long downtimes of the pump. Check valves are often provided in the hydraulic lines to prevent idling. However, check valves can indicate malfunctions, such as leakage, due to dirt or wear. In the case of an empty state, large suction heights and these check valves themselves increase the drawing in of the pump, especially at low oil temperatures. It is also known in so-called hydraulic power packs, i.e., hydraulic systems with an electrically driven pump that charges a pressure accumulator through which the hydraulic consumers are essentially dynamically supplied, to use the electric pump before the vehicle is started to load a pressure accumulator, which is emptied after a long period of idle time, for example when unlocking the vehicle.

It is therefore an object of the present disclosure to provide a particularly simple and inexpensive solution which prevents the hydraulic path from running empty in addition to hardware measures such as check valves.

According to the present disclosure, this object is achieved by a method for testing a hydraulic system, in particular for testing and/or establishing hydraulic readiness of the hydraulic system, wherein the hydraulic system has a pump which, in a first direction of rotation, conveys fluid to a first consumer for a volume flow function and, in a second direction of rotation conveys fluid to at least one second consumer for an actuation function, wherein at least one of the following is performed: testing hydraulic readiness of the hydraulic system; drawing fluid into the hydraulic system; ventilating the hydraulic system.

This has the advantage that simple measures prevent the hydraulic paths from running empty and/or, if necessary, restore the hydraulic readiness of the hydraulic system. In this way, it can advantageously be prevented that functional restrictions occur, especially after long idle periods.

Advantageous embodiments are explained below.

It is also useful if the hydraulic readiness of the hydraulic system is tested by rotating the pump in the second direction of rotation/actuation direction.

It is also advantageous if the fluid is drawn into the hydraulic system by rotating the pump in the first direction of rotation/cooling oil direction. In this way, the path that might have run empty can be filled up.

In a preferred embodiment, the hydraulic system can be ventilated by rotating the pump in the second direction of rotation/actuation direction. In this way, the air can advantageously be removed from the actuation path.

According to an advantageous further development of the preferred embodiment, the pump can be connected to the second consumer with the interposition of at least one valve, wherein the valve is switched into a ventilating position when ventilating the hydraulic system. This ensures that the air can escape from the hydraulic path.

It is also preferred if the steps of testing the hydraulic readiness of the hydraulic system, drawing the fluid into the hydraulic system, and/or ventilating the hydraulic system are performed repeatedly. Depending on the boundary conditions, an optimal result can be achieved in this way.

It is also advantageous if the steps of testing the hydraulic readiness of the hydraulic system, drawing the fluid into the hydraulic system, and/or ventilating the hydraulic system are performed in a predetermined sequence. The order of the steps can be different depending on the application and boundary conditions.

In addition, it is preferred if the steps of testing the hydraulic readiness of the hydraulic system, drawing the fluid into the hydraulic system and/or ventilating the hydraulic system are performed in a predetermined combination. This can advantageously ensure that the hydraulic readiness is reliably provided depending on the boundary conditions.

It is also useful if the hydraulic readiness of the hydraulic system is tested on the second consumer, wherein the second consumer is irrelevant/not critical to safety. This ensures that hazardous malfunctions do not occur when the path is empty.

The object of the present disclosure is also achieved by a hydraulic system for carrying out such a method, having a pump that can be driven in a first direction of rotation for a volume flow function and in a second direction of rotation for an actuation function.

In other words, the present disclosure relates to a method for establishing hydraulic readiness in a cooling and actuation system, wherein the solution according to the present disclosure includes: testing whether hydraulic readiness is present by turning the pump in the actuation direction; turning the pump in the direction of the cooling oil to draw in or to fill the suction path; ventilating the actuation path by turning the pump in the actuation direction and switching the valves accordingly. The measures mentioned can be performed in different order, combination and/or number of repetitions depending on the boundary conditions.

### BRIEF SUMMARY OF THE DRAWINGS

The present disclosure is explained below with the aid of a drawing. In the drawings:

FIG. 1 shows a perspective representation of a hydraulic system,

FIGS. 2 to 5 show a schematic block diagram of functions and queries of a method according to the present disclosure, and

FIGS. 6 and 7 show a schematic block diagram of an extension of the method illustrated in FIGS. 2 to 5.

### DETAILED DESCRIPTION

The figures are only schematic in nature and serve only for understanding the present disclosure. The same elements are provided with the same reference symbols. The features of the exemplary embodiments can be interchanged.

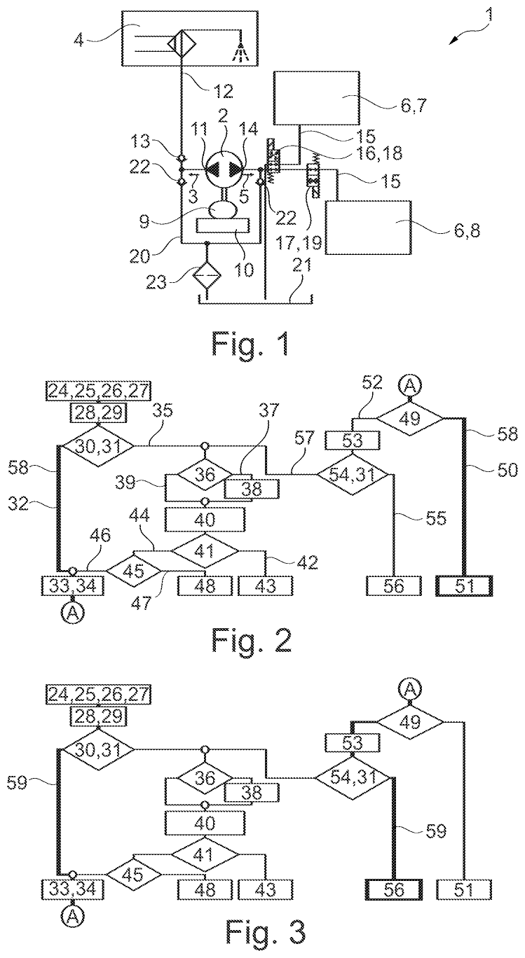

FIG. 1 shows a schematic illustration of the hydraulic system 1. The hydraulic system 1 has a pump 2 designed as a reversing pump. The pump 2 can be driven in a first direction of rotation 3. In the first direction of rotation 3, the pump 2 conveys fluid to a first consumer 3, such as a cooling oil device, for a volume flow function. The pump 2 can be driven in a second direction of rotation 5 opposite to the first direction of rotation 3. In the second direction of rotation 5, the reversing pump 2 conveys the fluid to at least one second consumer 6 for an actuation function. In the exemplary embodiment shown, the pump 2 conveys the fluid to two second consumers 6, for example to a parking lock actuator 7 and to a clutch 8.

The pump 2 is driven by an electric motor 9. The electric motor 9 is controlled via a control device 10. A first output 11 of the pump 2 is connected to the first consumer 3 via a cooling line 12 with a check valve 13 interposed. A second output 14 of the pump 2 is connected to a second consumer 6 via an actuation line/actuation path 15 with the interposition of a first valve 16. The second output 14 of the pump 2 is connected to the other second consumer 6 via the actuation line 15 with the interposition of the first valve 16 and a second valve 17. In the exemplary embodiment shown, the first valve 16 is designed as a 4/2-way valve 18. In the exemplary embodiment shown, the second valve 17 is designed as a 2/2-way valve 19.

The pump 2 is connected to a reservoir 21 via a suction path/drawing-in path 20. Two check valves 22 are arranged in the drawing-in path 20, which prevent the actuation line 15 from running empty. A suction filter 23 is arranged between the reservoir 21 and the drawing-in path 20.

FIGS. 2 to 5 show a sequence of the method according to the present disclosure for testing the hydraulic system 1. In a step 24, a vehicle approach 25, a vehicle unlocking device 26 and/or a vehicle opening 27 is/are detected. In a subsequent step 28, a wake-up signal 29 is sent to a control device 10 of the electric motor 9 of the pump 2.

A decision is then made in a decision step 30 as to whether a test of the hydraulic readiness 31 should be performed. If the decision 32 is negative, in a step 33 a rotation 34 is performed in the first direction of rotation 3 of the pump 2 with a defined speed profile. In the event of a positive decision 35, a decision is made in a decision step 36 as to whether a valve 16, 17 is present in the actuation path 15. If the decision 37 is positive, the actuation path 15 is actuated in a step 38 and one of the valves 16, 17 is switched if necessary. In the event of a negative decision 39 or after step 38, the pump 2 is rotated in the second direction of rotation 5 in a step 40 and sensor signals at the second consumer 6 are monitored.

In a decision step 41 it is checked whether a correlation is present between the rotation of the pump 2 and the sensor signals. In the event of a positive decision 42, a state 43 is present in which the hydraulic readiness of the hydraulic system 1 is reliably given. In the event of a negative decision 44, a check is made in a decision step 45 to determine whether a counter is at less than a predetermined limit value. In the event of a positive decision 46, step 33 is performed as already described. In the event of a negative decision 47, an error strategy 48 is performed.

After step 33, a decision is made in a decision step 49 as to whether the actuation path 15 should be ventilated. In the event of a negative decision 50, a state 51 is present in which the hydraulic readiness of the hydraulic system 1 is only given to a limited extent. With a positive decision 52, the actuation path 15 is ventilated in a step 53. For ventilation, the pump 2 is rotated in the second direction of rotation 5 and the valves 16, 17 are switched accordingly.

In a subsequent decision step 54 it is decided whether the test of the hydraulic readiness 31 should be performed. In the event of a negative decision 55, a state 56 is reached in which the hydraulic readiness of the hydraulic system 1 is given. In the event of a negative decision 57, decision step 36 is performed as already described.

In FIG. 2, an exemplary pathway 58 is highlighted with a thick line. The drawing-in path 20 is filled in step 33 without the hydraulic readiness test 31 being performed in step 30 and without the actuation path 15 being ventilated in step 49. As a result, the state 51 is reached in which the hydraulic readiness of the hydraulic system 1 is limited.

In FIG. 3, an exemplary pathway 59 is highlighted with a thick line. In this case, the drawing-in path 20 is filled in step 33 without the hydraulic readiness test 31 being performed in step 30. The actuation path 15 is ventilated in step 49, so that the state 56 is reached, in which the hydraulic readiness of the hydraulic system 1 is given.

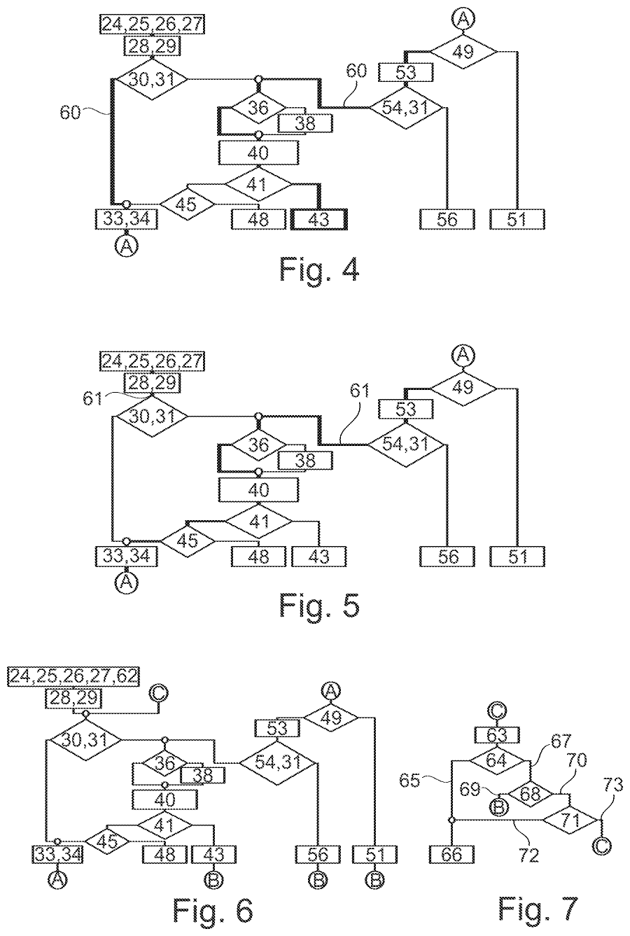

In FIG. 4, an exemplary pathway 60 is highlighted with a thick line. In this case, in step 30, the drawing-in path 20 is filled in step 33 without the hydraulic readiness test 31 being performed in step 30. The actuation path 15 is ventilated in step 49 and then the test of the hydraulic readiness 31 is initiated in step 54. For this purpose, in step 40 the pump 2 is rotated in the second direction of rotation 5, wherein a correlation to the sensor signals is established. Consequently, the state 43 is present in which the hydraulic readiness of the hydraulic system 1 is reliably given. The test of hydraulic readiness 31 is performed on a consumer that does not affect the safe state of the vehicle. For example, the closing of the clutch 8 is tested.

In FIG. 5, an exemplary pathway 61 is highlighted with a thick line. The actuation path 15 is ventilated in step 49 and then the test of the hydraulic readiness 31 is initiated in step 54. For this purpose, in step 40 the pump 2 is rotated in the second direction of rotation 5, wherein no correlation to the sensor signals is established. In step 45 it is determined that the counter limit value has not yet been reached. Therefore, step 33 is performed again.

In FIG. 6, step 30 is preceded by step 24, in which the vehicle approach 25, the vehicle unlocking device 26, the vehicle opening 27, and/or a driver identification 62 are/is detected, or a sequence C shown in FIG. 7 is upstream. In addition, the states 43, 51, and 56 are followed by a sequence B which contains further sub-functions and queries and is shown in more detail in FIG. 7.

In FIG. 7, a timer runs out in a step 63. In a subsequent decision step 64, it is checked whether the vehicle has been unlocked or the driver has been recognized. In the event of a negative decision 65, the control device 10 is shut down in a state 66. If the decision 67 is positive, a decision step 68 checks whether the timer is at less than a predetermined limit value. In the event of a negative decision 69, the method continues in step 63. If the decision 70 is positive, it is checked in a decision step 71 whether the vehicle has been unlocked or the driver has been recognized. If the decision 72 is negative, the control device 10 is shut down in the state 66. In the event of a positive decision 73, the method continues with step 30 (see FIG. 6). The sub-functions and queries shown in FIG. 7 are used in particular when the driver is not approaching or unlocking the vehicle after the vehicle has been stationary for a long time, since the driver is already in the vehicle.

### LIST OF REFERENCE SYMBOLS

1 Hydraulic system
2 Reversing pump
3 First direction of rotation/cooling oil direction
4 First consumer
5 Second direction of rotation/actuation direction
6 Second consumer
7 Parking lock actuator
8 Clutch
9 Electric motor
10 Control device
11 First output
12 Cooling line
13 Check valve
14 Second output
15 Actuation line/actuation path
16 First valve
17 Second valve
18 4/2-way valve
19 2/2-way valve
20 Drawing-in line/drawing-in path
21 Reservoir
22 Check valve
23 Suction filter
24 Decision step
25 Vehicle approach
26 Vehicle unlocking
27 Vehicle opening
28 Step
29 Wake-up signal
30 Decision step
31 Hydraulic readiness test
32 Negative decision
33 Step
34 Turn in the first direction of rotation
35 Positive decision
36 Decision step
37 Positive decision
38 Step
39 Negative decision
40 Step
41 Decision step
42 Positive decision
43 State
44 Negative decision
45 Decision step
46 Positive decision
47 Negative decision
48 Failure strategy
49 Decision step
50 Negative decision
51 State
52 Positive decision
53 Step
54 Decision step
55 Negative decision
56 State
57 Positive decision
58 Pathway
59 Pathway
60 Pathway
61 Pathway
62 Driver recognition
63 Step
64 Decision step
65 Negative decision
66 State
67 Positive decision
68 Decision step
69 Negative decision
70 Positive decision
71 Decision step
72 Negative decision
73 Positive decision

1. A method for testing a hydraulic system having a pump which, in a first direction of rotation, conveys fluid to a first consumer for a volume flow function and, in a second direction of rotation, conveys fluid to at least one second consumer for an actuation function, the method comprising at least one of the following steps:
testing hydraulic readiness of the hydraulic system;
drawing fluid into the hydraulic system; and
ventilating the hydraulic system.

2. The method according to claim 1, wherein the method includes testing hydraulic readiness of the hydraulic system and the hydraulic readiness of the hydraulic system is tested by rotating the pump in the second direction of rotation.

3. The method according to claim 1, wherein the method includes drawing fluid into the hydraulic system and the fluid is drawn into the hydraulic system by rotating the pump in the first direction of rotation.

4. The method according to claim 1, wherein the method includes ventilating the hydraulic system and the hydraulic system is ventilated by turning the pump in the second direction of rotation.

5. The method according to claim 4, wherein the pump is connected to the second consumer with an interposition of at least one valve, wherein the valve is switched into a ventilating position when ventilating the hydraulic system.

6. The method according to claim 1, wherein the steps of testing the hydraulic readiness of the hydraulic system, drawing the fluid into the hydraulic system, and/or ventilating the hydraulic system are performed repeatedly.

7. The method according to claim 1, wherein at least two of the steps of testing the hydraulic readiness of the hydraulic system, drawing the fluid into the hydraulic system and/or ventilating the hydraulic system are performed in a predetermined sequence.

8. The method according to claim 1, wherein at least two of the steps of testing the hydraulic readiness of the hydraulic system, drawing the fluid into the hydraulic system, and/or ventilating the hydraulic system are performed in a predetermined combination.

9. The method according to claim 2, wherein the hydraulic readiness of the hydraulic system is tested on the second consumer, wherein the second consumer is irrelevant to safety.

10. A hydraulic system comprising:
a pump drivable in a first direction of rotation for a volume flow function and in a second direction of rotation for an actuation function; and
a control device configured for testing the hydraulic system by performing at least one of the following:
testing hydraulic readiness of the hydraulic system;
drawing fluid into the hydraulic system; and
ventilating the hydraulic system.

11. The hydraulic system as recited in claim 10 further comprising a reservoir and a drawing-in path providing hydraulic fluid from the reservoir to the pump, the drawing of fluid into the hydraulic system including drawing hydraulic fluid from the reservoir into the drawing-in path.

12. The hydraulic system as recited in claim 10 further comprising a valve for an actuation path for providing fluid from the pump for the actuation function to a hydraulic consumer, the control device configured to make a decision as to whether the testing of hydraulic readiness of the hydraulic system is to be performed and then:
if the decision is negative, rotating the pump in the first direction of rotation with a defined speed profile, and
if the decision is positive, determining whether the valve is present in the actuation path.

13. The hydraulic system as recited in claim 10 further comprising a first consumer and a second consumer, the pump configured for conveying hydraulic fluid to the first consumer for the volume flow function by rotating in the first direction of rotation and for conveying hydraulic fluid to the second consumer for the actuation function by rotating in the second direction of rotation.

14. The hydraulic system as recited in claim 13 wherein the controller is configured to monitor sensor signals at the second consumer upon rotation of the pump in the second direction to determine if the hydraulic system is in a state in which the hydraulic readiness of the hydraulic system is reliably given.

15. A method for testing a hydraulic system having a pump rotatable in a first direction to provide hydraulic fluid to a first consumer and rotatable in a second direction to provide hydraulic fluid to a second consumer, the method comprising:
receiving a wake-up signal;
in response to the wake-up signal, operating the hydraulic system by performing at least one of the following steps:
testing a hydraulic readiness of the hydraulic system to provide fluid from the pump to the second consumer via an actuation path for an actuation function;
drawing fluid from a reservoir to fill a drawing-in path between the pump and the reservoir; and
ventilating the actuation path.

16. The method as recited in claim 15 wherein the operating of the hydraulic system includes:
the testing of the hydraulic readiness of the hydraulic system; and
when the hydraulic readiness of the hydraulic system is only given to a limited extent, the ventilating of the actuation path.

17. The method as recited in claim 15 wherein the operating of the hydraulic system includes:
the drawing of fluid from the reservoir to fill the drawing-in path.

18. The method as recited in claim 15 wherein the operating of the hydraulic system includes:
the drawing of fluid from the reservoir to fill the drawing-in path; then
the ventilating of the actuation path; and then
the testing of the hydraulic readiness of the hydraulic system.

19. The method as recited in claim 15 wherein the operating of the hydraulic system includes:
the ventilating of the actuation path; then
the testing of the hydraulic readiness of the hydraulic system; and then
the drawing of fluid from the reservoir to fill the drawing-in path.
